(19) United States
(12) Patent Application Publication
(10) Pub. No.: US 2014/0016116 A1
(43) Pub. Date: Jan. 16, 2014

(54) System and method for raman-based chronic exposure detection

(71) Applicant: Chemlmage Corporation, Pittsburgh, PA (US)

(72) Inventors: John Maier, Pittsburgh, PA (US); Jeffrey Cohen, Pittsburgh, PA (US); Ryan Priore, Wexford, PA (US)

(21) Appl. No.: 13/987,046

(22) Filed: Jun. 28, 2013

Related U.S. Application Data
(63) Continuation of application No. 13/374,168, filed on Dec. 14, 2011, now abandoned.

(51) Int. Cl. G01N 21/84

(52) U.S. Cl. CPC G01N 21/84
USPC 356/39; 356/301

(57) ABSTRACT

The present disclosure provides for a system and method for assessing chronic exposure of a biological sample, such as a bodily fluid, to an analyte of interest. A biological sample may be illuminated to thereby generate a one or more pluralities of interacted photons. These interacted photons may be detected to thereby generate one or more spectroscopic data sets representative of a biological sample. Spectroscopic data sets generated may be compared to at least one reference data set. Each reference data set may be associated with a known exposure to a known analyte. The present disclosure contemplates that the system and method disclosed herein may be used to analyze exposure of biological samples to at least one analyte over time. Data sets may be obtained at various time intervals to assess changes in a molecular composition as a result of chronic exposure to an analyte.

### RELATED APPLICATIONS

This Application is a Continuation of pending U.S. patent application Ser. No. 13/541,171, filed on Jul. 3, 2012, entitled “System and Method for Raman Based Chronic Exposure Detection,” which itself is a Continuation of pending U.S. application Ser. No. 13/374,168, filed on Dec. 14, 2011, entitled “System And Method For Raman Based-Chronic Exposure Detection,” which itself claims priority under 35 U.S.C. §119(e), to pending U.S. Provisional Patent Application No. 61/459,561, filed on Dec. 14, 2010, entitled “System and Method for Raman-Based Chronic Exposure Detection.” Each of these Applications is hereby incorporated by reference in its entirety.

### BACKGROUND

The biochemical composition of a biological sample may comprise a complex mix of biological molecules including, but not limited to, proteins, nucleic acids, lipids, and carbohydrates. A biological sample may comprise a cell, tissue, and/or bodily fluid. Various types of spectroscopy and imaging may be explored for analysis of biological samples. Raman spectroscopy is based on irradiation of a sample and detection of scattered radiation, and it can be employed non-invasively to analyze biological samples in situ. Thus, little or no sample preparation is required. Raman spectroscopy techniques can be readily performed in aqueous environments because water exhibits very little, but predictable, Raman scattering. It is particularly amenable to in vivo measurements as the powers and excitation wavelengths used are non-destructive to the tissue and have a relatively large penetration depth.

Chemical imaging is a reagentless tissue imaging approach based on the interaction of laser light with tissue samples. The approach yields an image of a sample wherein each pixel of the image is the spectrum of the sample at the corresponding location. The spectrum carries information about the local chemical environment of the sample at each location. For example, Raman chemical imaging (RCI) has a spatial resolving power of approximately 250 nm and can potentially provide qualitative and quantitative image information based on molecular composition and morphology.

Instruments for performing spectroscopic (i.e. chemical) analysis typically comprise an illumination source, image gathering optics, focal plane array imaging detectors and imaging spectrometers. In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane-array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging, systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the an entire area encompassing the sample simultaneously using an electronically tunable optical imaging filter such as an acousto-optic tunable filter (AOTF), a multi-conjugate tunable filter (MCF), or a liquid crystal tunable filter (LCTF). Here, the organic material in such optical filters are actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image.

Assessing biological samples may require obtaining the spectrum of a sample at different wavelengths. Conventional spectroscopic devices operate over a limited range of wavelengths due to the operation ranges of the detectors or tunable filters possible. This enables analysis in the Ultraviolet (UV), visible (VIS), infrared (IR), near infrared (NIR), short wave infrared (SWIR) mid infrared (MIR) wavelengths and to some overlapping ranges. These correspond to wavelengths of about 180-380 nm (UV), 380-700 nm (VIS), 1000-2500 nm (IR), 700-2500 nm (NM), 850-1700 nm (SWER) and 2500-25000 nm (MIR).

Some research has demonstrated that the analysis of bodily fluid may hold potential for assessing clinical disease state, for example in the setting of myocardial infarction. This work has been focused on analysis of endogenous molecules, which can change in response to a particular disease state. Analysis of endogenous molecules may measure the reaction of a molecular environment in response to an internal physiological occurrence. This approach does not provide for the analysis of changes in a molecular environment in response to an exogenous agent. There exists a need for measuring a change in a molecular environment of a biological sample in response to such an exogenous agent, such as an analyte of interest.

Currently, the state of the art in terms of chronic exposure monitoring consists of HgbAlc, which measures chronic exposure to elevated blood sugar. Chronic exposure to elevated glucose causes hemoglobin molecules to accrue glycoadloatal sites. The amount of glycosylation can be measured through established chemical assays. The method's dependence on a particular chemical reaction limits the application of this methodology. Therefore, there exists a need for a system and method of assessing biological samples that is reagentless and not dependent on a specific chemical reaction. Such a system and method may hold potential for application in analyzing chronic exposure to an analyte.

### SUMMARY OF THE INVENTION

The present disclosure provides for a system and method for analyzing exposure of a biological sample to an analyte of interest. The invention applies spectroscopic techniques such as Raman and infrared spectroscopy to detect changes in the molecular composition of biological samples. Spectroscopic techniques hold potential for acquiring measurements that are sensitive to molecular concentrations and changes in molecular structure. Chemicals to which people and/or animals are exposed can cause changes in molecular concentration. Additionally, through bonding, this exposure can cause changes in molecular structure. This change in molecular composition may be indicative of exposure of the biological sample (and therefore exposure of an individual supplying a biological sample) an analyte such as a drug, alcohol, a chemical, a toxin, and allergen, among others. The system and method disclosed herein hold potential for quantitatively assessing chronic exposure to an analyte over time.

Raman and/or infrared spectroscopic techniques may be of particular use in the analysis of dried droplets of bodily fluids because of the influence of constituents of the droplet on the spatial pattern of drying. Due to the properties associated with drying, imaging can determine more specific information about specific molecular families.

Raman and/or infrared spectroscopy may hold potential for detecting moieties at very small concentrations. In this case, a change in the molecular environment, which essentially amplifies the signal is detected, as opposed to a low concentration molecule.

Analysis may be focused on signals correlated with a history of exposure on different time scales. These signals may manifest themselves through changes in molecular concentration, or structural changes that occur in molecules in a fluid sample.

The system and method disclosed herein hold potential for assessing and measuring the exposure of many different analytes not currently available today, but of potential clinical interest. The invention overcomes the limitations of the prior art by not relying on reagents or chemical reactions as part of the measurements.

### BRIEF DESCRIPTION OF THE DRAWINGS

The accompanying drawings, which are included to provide further understanding of the disclosure and are incorporated in an constitute a part of this specification illustrate embodiments of the disclosure, and together with the description, serve to explain the principles of the disclosure.

In the drawings:

FIG. 1 is representative of a system of the present disclosure.

FIG. 2 is representative of a system of the present disclosure.

FIG. 3 is representative of a method of the present disclosure.

FIG. 4 is illustrative of a method of the present disclosure.

FIG. 5 is representative of mean spectra of BSA and a-BSA.

FIGS. 6A and 6B are representative of spectra used for PLSD analysis.

FIG. 7 is representative of cross validation vs. number of factors.

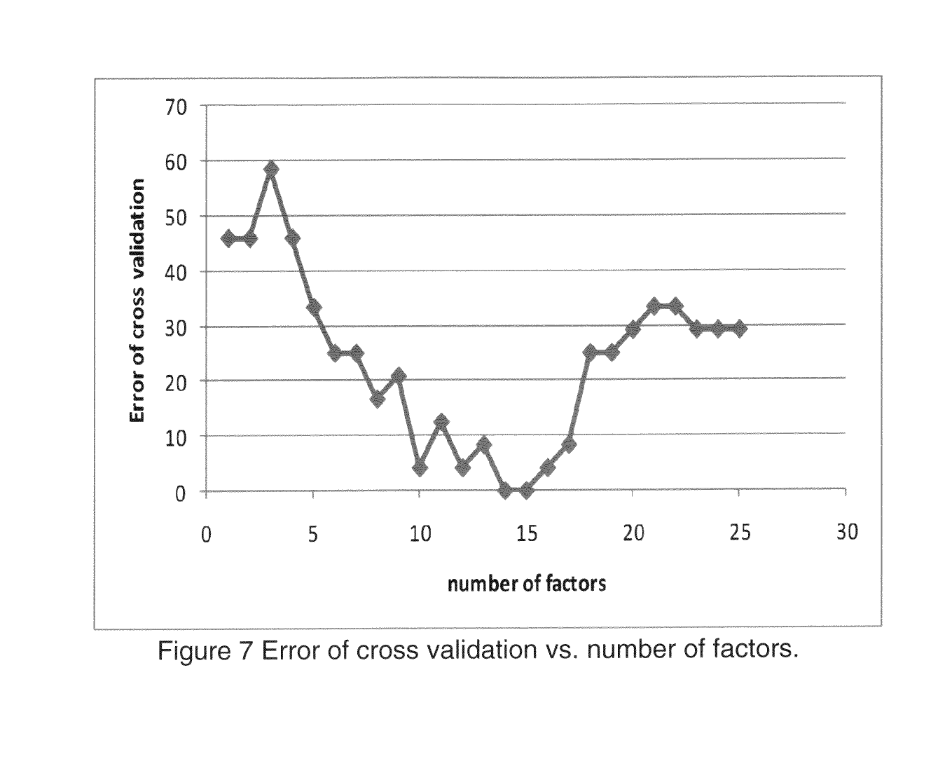

FIG. 8 is representative of a ROC curve comparison of Raman vs. IR spectrsoscopies for detection of a-BSA in serum.

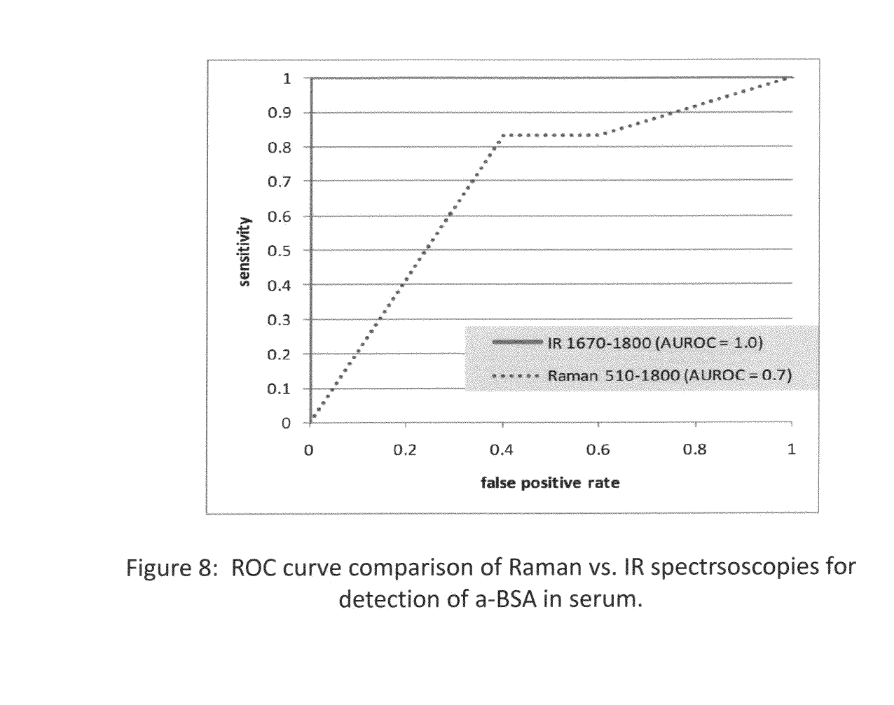

### DETAILED DESCRIPTION

Reference will now be made in detail to the preferred embodiments of the present disclosure, examples of which are illustrated in the accompanying drawings. Wherever possible, the same reference numbers will be used throughout the specification to refer to same or like parts.

The patent or application file contains at least one drawing executed in color. Copies of this patent or patent application publication with color drawing(s) will be provided by the Office upon request and payment of the necessary fee.

The present disclosure provides for analyzing biological samples to assess exposure of said biological sample to one or more analytes of interest. In one embodiment, the present disclosure contemplates that a biological sample may comprise a biological fluid. This biological fluid may comprise a blood, plasma, or blood serum sample. In one embodiment, a biological fluid may be dried on a substrate. A substrate may comprise an aluminum coated glass. In one embodiment, this substrate may comprise a slide suitable for Raman measurements. Certain substrates can provide an amplification of the Raman scattering. These may be appropriate substrates for such analysis. An example of such a substrate may comprise Klarite® SERs substrates.

In another embodiment, a biological sample may be assessed in a semi liquid state. The system and method contemplated by the present disclosure may be applied to substantially any bodily fluid and/or exogenous fluids used to rinse or wash an organ or tissue.

The system and method disclosed herein may be applied to unprocessed body fluid samples and/or applied to body fluid samples after some level of processing. In one embodiment, the body fluid may be processed to remove debris or cellular material. Such sample processing may also include chemically active steps which modify molecular structures of some of the molecules in fluid or add a sensitivity moiety or tag of some kind to the same subset of molecules.

The system and method of the present disclosure hold potential for application in a number of scenarios. In one embodiment, the invention of the present disclosure may be applied to toxicology analysis. In such an application the system and method of the present disclosure may be applied to analyze drugs including, but not limited to, the following: alcohol, cocaine, methamphetamine, heroin, opiates, methadone, barbiturates, stimulates such as methylphenidate, and combinations thereof. In another embodiment, the invention of the present disclosure may be applied to analyze environmental exposure such as chronic allergies. These allergies may include but are not limited to: pollen, mold, smoke, exhaust, and combinations thereof.

In yet another embodiment, the invention of the present disclosure may be applied to the analysis of chronic exposure to chemicals. These chemicals may include but are not limited to lead, melamine and combinations thereof. This embodiment may also contemplate the analysis of chemicals that troops may be exposed to in the field, such as chemical warfare agents.

In one embodiment, the invention of the present disclosure may be applied to the analysis of food allergies. These may include but are not limited to: peanuts, soy, milk, and combinations thereof. The invention of the present disclosure may also be applied to the analysis of pharmaceuticals. These may include but are not limited to: over the counter (OTC) medicines, prescription medicines, nutraceuticals, and combinations thereof.

In yet another embodiment, the invention of the present disclosure may be applied to the analysis of nutritional factors. This may include but is not limited to the analysis of: metabolic syndrome screening, lipid profile screening, lipid management screening, and combinations thereof.

The system and method of the present disclosure may also be applied to assessment of immune response. In one embodiment, this assessment may comprise the assessment of immune response in the setting of allergen exposure or potentially in monitoring autoimmune disease.

In yet another embodiment, if the analyte itself is a therapeutic agent, the system and method of the present disclosure may be used to monitor various treatments. An individual's response to a treatment can be monitored for its effectiveness. For example, this monitoring may comprise analyzing mandatory therapy for drug resistant tuberculosis treatment.

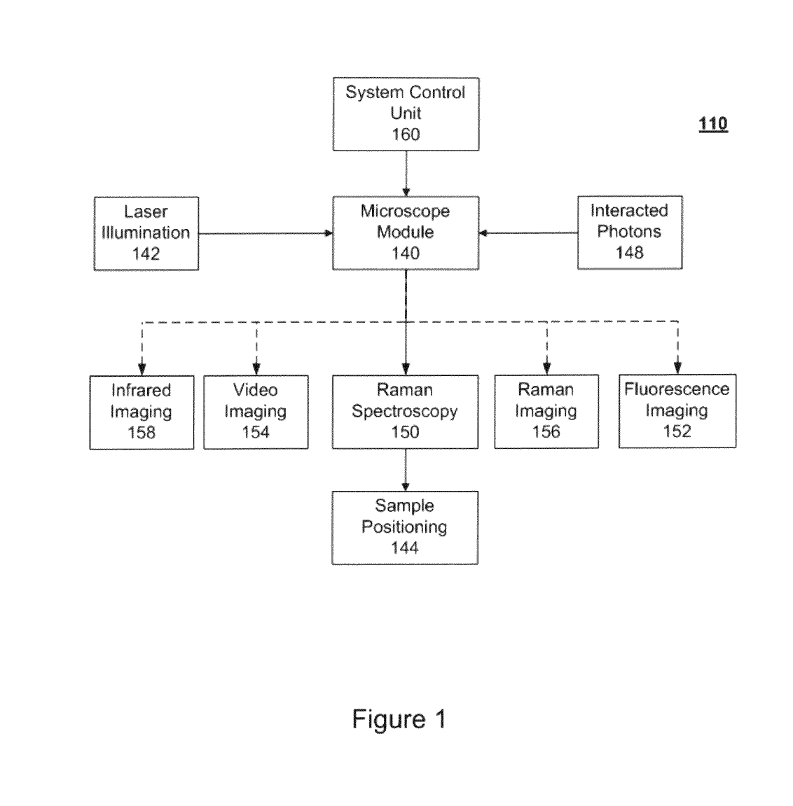

FIG. 1 is illustrative of a system of the present disclosure. The layout in FIG. 1 may relate to a chemical imaging system marketed by ChemImage Corporation of Pittsburgh, Pa. or its subsidiary. In one embodiment, the system 110 may include a microscope module 140 containing optics for microscope applications. An illumination source 142 (e.g., a laser illumination source) may provide illuminating photons to a sample (not shown) handled by a sample positioning unit 144 via the microscope module 140. In one embodiment, illumination source 142 may comprise a laser configured so as to illuminate a biological sample with 532 nm laser excitation. In another embodiment, an illumination source 142 may comprise a laser configured so as to illuminate a biological sample with 785 nm laser excitation.

In one embodiment, interacted photons (not shown) may pass through the microscope module (as illustrated by exemplary block 148 in FIG. 1) before being directed to one or more of spectroscopy or imaging optics in the system 110. The system of FIG. 1 may be configured so as to generate at least one Raman data set representative of a sample under analysis. In the embodiment of FIG. 1, Raman spectroscopy 150 is illustrated as standard. In other embodiments, widefield Raman imaging 156, fluorescence imaging 152, infrared imaging 158 and video imaging 154 may also be implemented.

The system 110 may also include a control unit 160 to control operational aspects (e.g., focusing, sample placement, laser beam transmission, etc.) of various system components including, for example, the microscope module 140 and the sample positioning unit 144 as illustrated in FIG. 1. In one embodiment, operation of various components (including the control unit 160) in the spectroscopy module 110 may be fully automated or partially automated, under user control.

It is noted here that in the discussion herein the terms “illumination,” “illuminating,” “irradiation,” and “excitation” are used interchangeably as can be evident from the context. For example, the terms “illumination source,” “light source,” and “excitation source” are used interchangeably. Similarly, the terms “illuminating photons” and “excitation photons” are also used interchangeably. Furthermore, although the discussion herein below focuses more on Raman spectroscopy and imaging, various methodologies discussed herein may be adapted to be used in conjunction with other types of spectroscopy applications as can be evident to one skilled in the art based on the discussion provided herein.

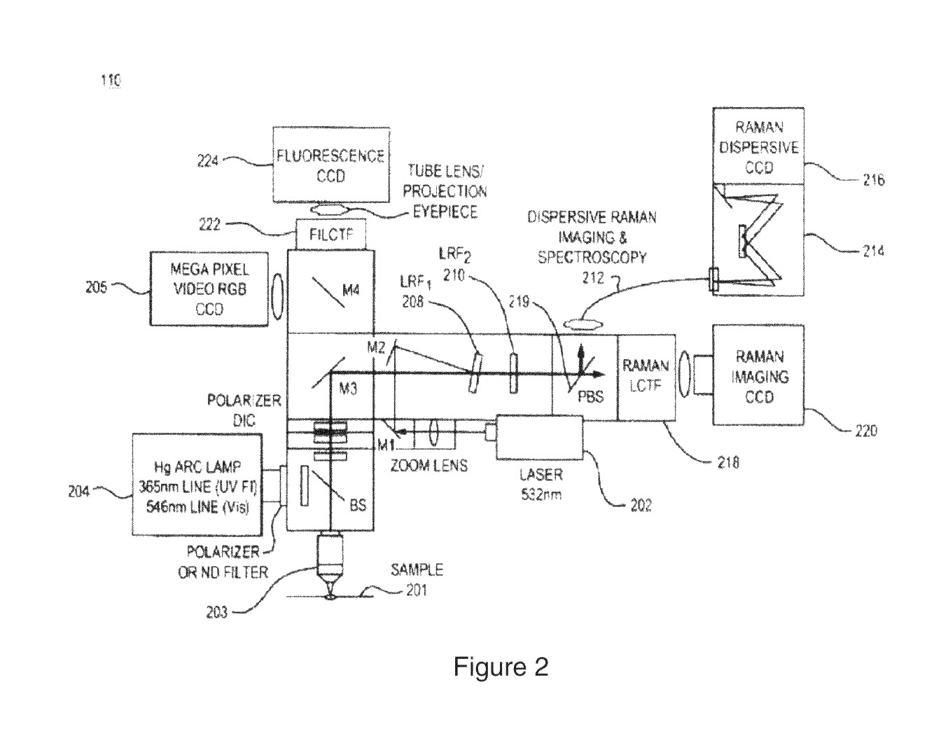

FIG. 2 illustrates exemplary details of the system 110 in FIG. 1 according to one embodiment of the present disclosure. A system 110 may operate in several experimental modes of operation including bright field reflectance and transmission imaging, polarized light imaging, differential interference contrast (DIC) imaging, UV induced autofluorescence imaging, NIR imaging, wide field illumination whole field Raman spectroscopy, wide field spectral fluorescence imaging, wide field visible imaging, and wide field spectral Raman imaging. Module 110 may include collection optics 203, light sources 202 and 204, and a plurality of spectral information processing devices including, for example: a tunable fluorescence filter 222, a tunable Raman filter 218, a dispersive spectrometer 214, a plurality of detectors including a fluorescence detector 224, and Raman detectors 216 and 220, a fiber array spectral translator (“FAST”) device 212, filters 208 and 210, and a polarized beam splitter (PBS) 219.

In one embodiment, at least one light source 202 and 204 may comprise a tunable light source. In another embodiment, at least one light source 202 and 204 may comprise a mercury arc lamp. In yet another embodiment, at least one light source 202 and 204 may comprise a monochromatic light source.

At least one Raman detector 216 and 220 may be configured so as to generate at least one test Raman data set representative of a sample under analysis. This test data set may comprise at least one of a Raman chemical image, a Raman hyperspectral image, a Raman spectrum, and combinations thereof. In one embodiment, at least one Raman detector may comprise a detector selected from the group consisting of: a CCD, an ICCD, a CMOS detector, and combinations thereof. A Raman detector, in one embodiment, may comprise a focal plane array detector.

In one embodiment, a tunable filter may be selected from the group consisting of: a Fabry Perot angle tuned filter, an acousto-optic tunable filter, a liquid crystal tunable filter, a Lyot filter, an Evans split element liquid crystal tunable filter, a Solc liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, a liquid crystal Fabry Perot tunable filter, and a multi-conjugate tunable filter, and combinations thereof.

In one embodiment, a system of the present disclosure may comprise filter technology available from ChemImage Corporation, Pittsburgh, Pa and its subsidiary. This technology is more fully described in the following U.S. Patents and Patent Applications: U.S. Pat. No. 6,992,809, tiled on Jan. 31, 2006, entitled “Multi-Conjugate Liquid Crystal Tunable Filter,” U.S. Pat. No. 7,362,489, filed on Apr. 22, 2008, entitled “Multi-Conjugate Liquid Crystal Tunable Filter,” U.S. Pat. No. 13/066,428, filed on Apr. 14, 2011, entitled “Short wave infrared multi-conjugate liquid crystal tunable filter.” These patents and patent applications are hereby incorporated by reference in their entireties.

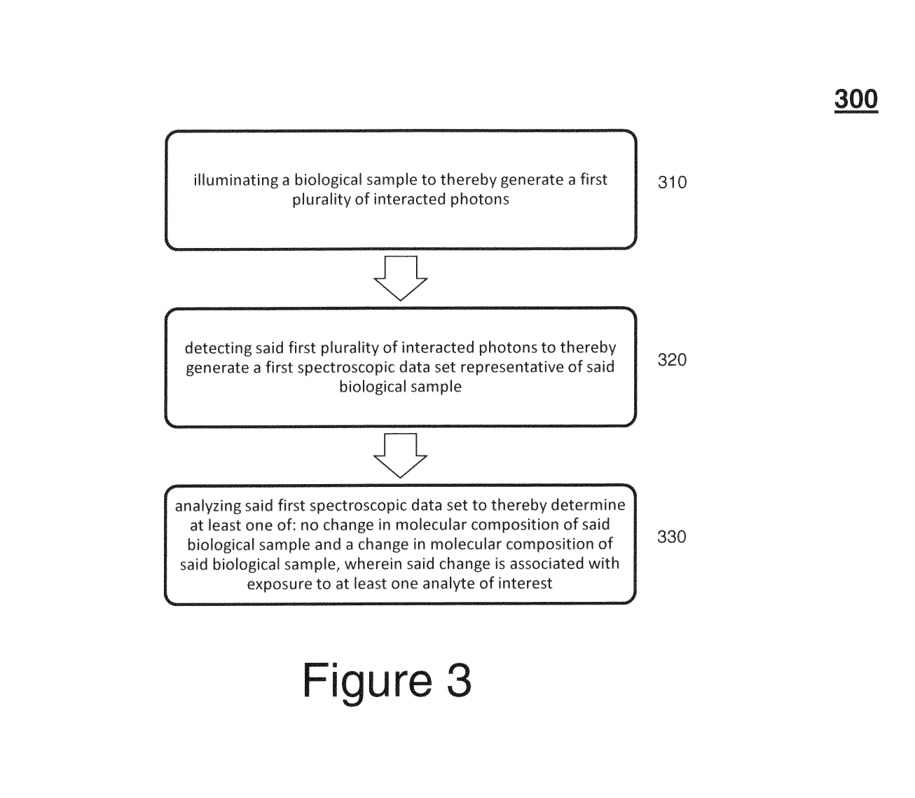

In one embodiment, the present disclosure provides for a method 300, illustrated by FIG. 3. The method 300 may comprise illuminating a biological sample to thereby generate a first plurality of interacted photons in step 310. This plurality of interacted photons may comprise photons selected from the group consisting of photons scattered by said biological sample, photons reflected by said biological sample, photons absorbed by said biological sample, photons emitted by said biological sample, and combinations thereof.

In one embodiment a plurality of interacted photons may be passed through a tunable filter to thereby sequentially filter said plurality of interacted photons into a plurality of predetermined wavelength bands.

In step 320, a first plurality of interacted photons may be detected to thereby generate a first spectroscopic data set representative of said biological sample. In one embodiment, a first spectroscopic data set may comprise at least one of: a Raman spectra representative of said biological sample, a hyperspectral Raman image representative of said sample, and combinations thereof. In another embodiment, a first spectroscopic data set may comprise at least one of: an infrared spectra representative of said biological sample, a hyperspectral infrared image representative of said sample, and combinations thereof.

In step 330, a first spectroscopic data set may be analyzed to thereby determine whether or not a change in molecular composition of said biological sample has occurred, wherein said change is associated with exposure to at least one analyte of interest. The present disclosure contemplates that an analyte of interest may comprise, but is not limited to, at least one of: a chemical, an allergen, a toxin, a drug, an alcohol, and combinations thereof.

The analysis of step 330 may further comprise comparing a first spectroscopic data set to at least one reference data set, wherein each reference data set may be associated with a known exposure to a known analyte.

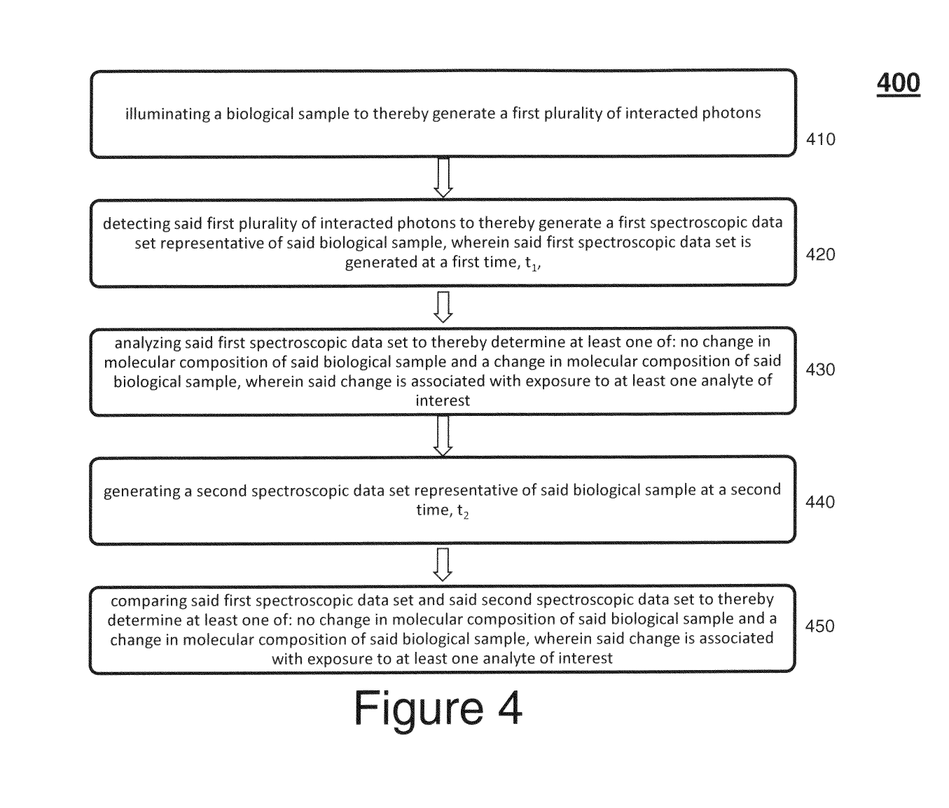

In another embodiment, illustrated by FIG. 4, a method 400 may assess exposure of a biological sample to an analyte over time. In such an embodiment, a biological sample may be illuminated in step 410 to thereby generate a first plurality of interacted photons. In step 420 a first plurality of interacted photons may be detected to thereby generate a first spectroscopic data set representative of said biological sample, wherein said first spectroscopic data set is generated at a first time, t.sub.1. A second spectroscopic data set representative of a biological sample may be generated at a second time, t.sub.2, in step 430. A first spectroscopic data set and a second spectroscopic data set may be compared in step 440 to thereby determine if a change in molecular composition in a biological sample.

In one embodiment, a method 400 may further comprise comparing at least one of a first spectroscopic data set and a second spectroscopic data set to at least one reference data set, wherein each reference data set is associated with a known exposure to a known analyte.

In one embodiment, comparison of one or more spectroscopic data sets to reference data sets may be achieved using a multivariate technique such as a chemometric technique. This chemometric technique may be selected from the group consisting of: principle component analysis, linear discriminant analysis, partial least squares discriminant analysis, maximum noise fraction, blind source separation, band target entropy minimization, cosine correlation analysis, classical least squares, cluster size insensitive fuzzy-c mean, directed agglomeration clustering, direct classical least squares, fuzzy-c mean, fast non negative least squares, independent component analysis, iterative target transformation factor analysis, k-means, key-set factor analysis, multivariate curve resolution alternating least squares, multilayer feed forward artificial neural network, multilayer perception-artificial neural network, positive matrix factorization, self modeling curve resolution, support vector machine, window evolving factor analysis, and orthogonal projection analysis.

In one embodiment a processor may be configured so as to perform comparisons between a reference data set and one or more spectroscopic data sets. The present disclosure further contemplates that a machine readable program code, which when executed by a processor, may cause said processor to perform such comparisons. In another embodiment, the present disclosure provides for a storage medium containing machine readable program code, which, when executed by a processor, causes said processor to perform the methods disclosed herein.

### EXAMPLE

The Example provided herein is representative of one embodiment contemplated by the present disclosure. The Example illustrates the application of infrared microspectroscopy to determine whether acetylation of albumin can be detected in serum samples. Infrared analysis holds potential for sensitivity to acetylation in biological samples.

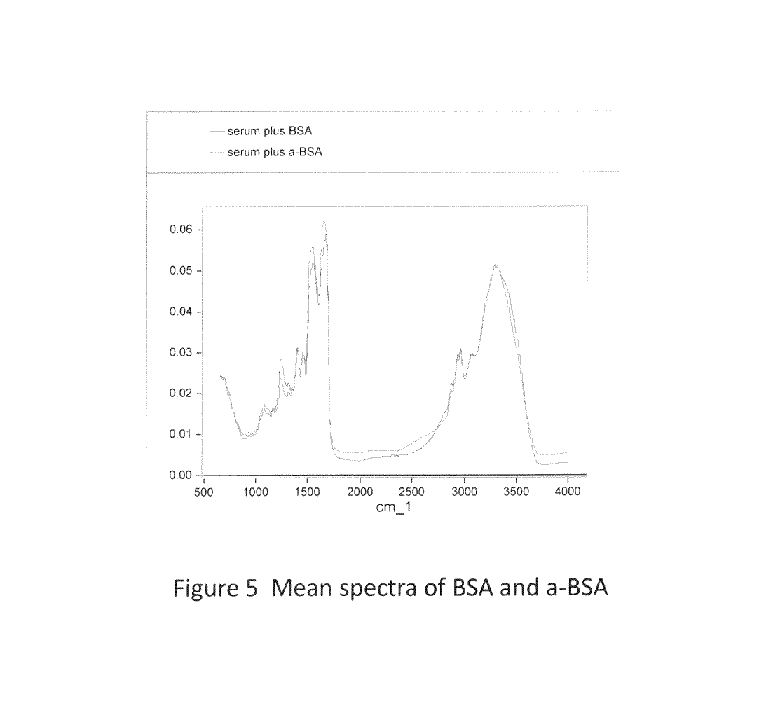

FIG. 5 shows mean IR spectra of the samples of serum with Bovine Serum Albumin (BSA) and with acetylated BSA (a-BSA). The region from 1670-1800 wavenumbers is highlighted because of the feature in IR spectroscopy associated with carbonyl at 1730 wavenumbers. FIG. 5 shows the means of 12 spectra each recorded from serum with BSA and serum with a-BSA.

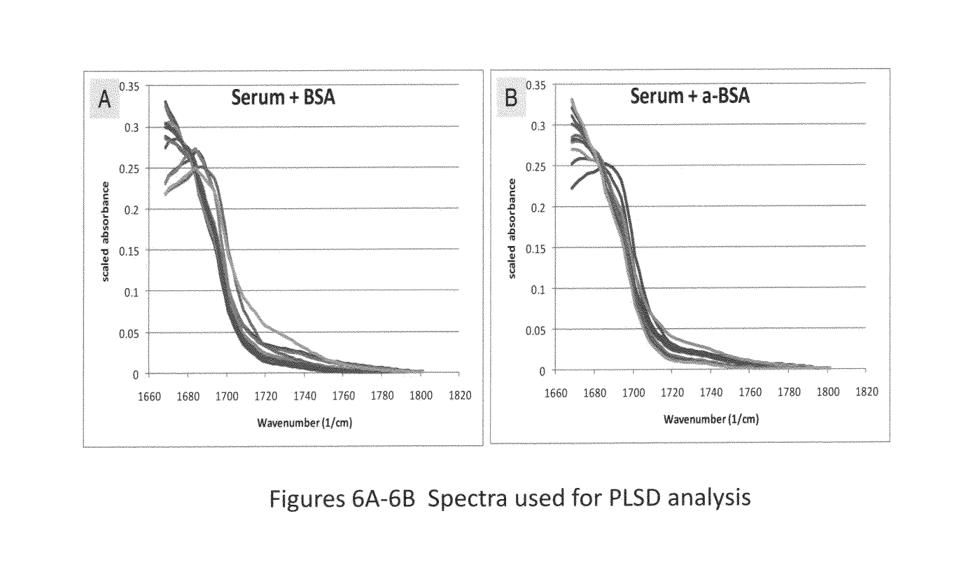

Multivariate analysis was carried out on these spectra. The analysis was performed on data from the spectral region from 1670 to 1800 wavenumber. The spectra used in the analysis are shown in FIGS. 6A-6B. FIG. 6A shows the spectra from serum plus BSA. FIG. 6B shows the spectra from serum plus a-BSA.

Partial least squares discriminate analysis (PLSDA) with cross validation was performed on the data. The classification results were perfect using data from this spectral range. Table 1 shows the parameters used and metrics from the analysis. The number of factors was chosen by analysis of error of cross validation.

TABLE 1

| Variable | Value |
|---|---|
| Number of spectra | 24 |
| Number of factors used | 15 |
| Confusion misclassification rate | 0% |
| Cross-validation misclassification rate | 0% |
| Mean percent variance explained | x-block: 99.9% y-block: 99.4% |

This work demonstrates the potential of IR spectroscopy in terms of discriminating serum spiked with BSA from serum spiked with a-BSA. There is no clear spectral feature in the 1730 wavenumber area, yet the cross validation performance is perfect. This is likely due to shifts in the neighboring peak at approximately 1675 wavenumbers. Peaks in this range are attributed to C—C bonds, but can have contributions from C.dbd.O bonds as well.

While the disclosure has been described in detail and with reference to specific embodiments thereof, it will be apparent to one skilled in the art that various changes and modifications can be made therein without departing from the spirit and scope of the embodiments. Additionally, although the present disclosure is focused on the use of Raman and infrared spectroscopic techniques, it is contemplated that the system and method described herein may be applied to ultraviolet, visible, fluorescence, and additional infrared ranges (short wave infrared, near infrared, mid infrared, and far infrared). Thus, it is intended that the present disclosure cover the modifications and variations of this disclosure provided they come within the scope of the present disclosure and its equivalents.

What is claimed is:

1. A method comprising:
illumining a biological sample to generate at least one plurality of interacted photons;
collecting the plurality of interacted photons and generating at least one Raman data set representative of the biological sample; and
analyzing the Raman data set to thereby determine at least one disease state associated with the biological sample.

2. The method of claim 1 wherein the disease state is further indicative of a change in the molecular composition of the biological sample.

3. The method of claim 2 wherein the change is further a response to at least one analyte.

4. The method of claim 3 wherein the analyte further comprises at least one of: a chemical, an allergen, a therapeutic agent, a toxin, a drug, and an alcohol.

5. The method of claim 1 wherein analyzing the Raman data set further comprises comparing the Raman data set to at least one reference data set, wherein each reference data set is associated with a known disease state.

6. The method of claim 5 wherein the comparison is further achieved by applying at least one chemometric technique.

7. The method of claim 6 wherein the chemometric technique further comprises Partial least squares discriminate analysis.

8. The method of claim 1 wherein the biological sample further comprises at least one biological fluid.

9. The method of claim 8 wherein the biological sample further comprises at least one of: blood, blood plasma, and blood serum.

10. The method of claim 1 wherein the biological sample further comprises at least one exogenous fluid.

11. The method of claim 1 wherein the Raman data set further comprises at least one of: a Raman spectrum and a Raman chemical image.

12. The method of claim 11 wherein the Raman data comprises a Raman chemical image, further comprising assessing the spatial pattern of the biological sample.

13. The method of claim 1 wherein the biological sample is dried on a substrate.

14. The method of claim 13 wherein the substrate further comprises at least one of: a microscope slide and a SERS substrate.

15. The method of claim 13 wherein the substrate further comprises aluminum coated glass.

16. The method of claim 1 wherein the biological sample is further in at least one of a liquid state and a semi-liquid state.

17. The method of claim 1 wherein the biological sample is illuminated using wide-field illumination.

18. The method of claim 1 further comprising passing the plurality of interacted photons through a fiber array spectral translator device.

19. The method of claim 1 wherein the Raman data set is generated at a time, t₀, further comprising:
generating at least one other Raman data set at a time, t₁; and
assessing the Raman data set to thereby determine at least one disease state associated with the biological sample.

20. The method of claim 19 wherein the disease state is further indicative of a change in the molecular composition of the biological sample due to a response to at least one analyte, wherein the analyte further comprises at least one therapeutic agent.
